(19) United States
(12) Patent Application Publication
(10) Pub. No.: US 2005/0040653 A1
(43) Pub. Date: Feb. 24, 2005

(54) Speed of light engine

(76) Inventor: Timothy Leight McCormick, Denver, CO (US)

Correspondence Address: TIM McCORMICK, 7450 W. 52ND AVE. #M309, ARVADA, CO, 80002, US

(21) Appl. No.: 10/642,804

(22) Filed: Aug. 19, 2003

(51) Int. Cl. H02P 9/04

(52) U.S. Cl. 290/1 R

(57) ABSTRACT

The S.O.L.E. Engine Uses Solenoids, That Are Connected To Plunger Rods, That Are Connected With The Crank, Shaft Wich Is The Power Output Of The Engine. Crank Shaft Power Output From The Engine, Too Turn The Generator, Thus Returning Electricty To The Battery. Solenoids Are A New Innovated Design In Engine Technology.

### DETAILED DESCRIPTION OF THE INVENTION

This Engine is Designed to continually Supply Itself with Fuel (Electricity) Threw A Prenergized Battery, Regulated Buy a Computer, Threw wich Energizes Solenoid Plungers To Solenoid Plunger Rods, To Turn Engine Crank, And Rotate Crank Pulley. Crank Pulley connected By Belt To D.C.Generator Pulley, Rotating D.C.Generator Returning Fuel (Electricity) Threw Voltage Regulation, By The (Computer) From the Computer Returning to the Battery Only What Electricty Has Actually Been Used! Thus Refueling/Regenerating Itself!

The Purpose Creating This Engine is too Elimanate as much Fossil Fuel Emissions as Possiable, Thus Being The First Engine of its Kind!

The process of Making, And Obtaining Material, Can Be Sought Threw Any Major Independent Engine Manufacturing Company Anywhere.

### BRIEF DESCRIPTION OF THE SEVERAL VIEWS OF THE DRAWING

FIG. 1 page 1

Front View Of The Engine Block

1) Engine Block.

2) D.C.Generator.

3) Electric Solenoids & Springs.

4) Solenoid Plungers.

5) Plunger Connecting Rods.

6) Balnced Engine Crank.

7) Engine Block Oil Pan.

8) Solenoid Covers.

9) Generator Braces.

FIG. 2 page 2

Left Side View Engine Block

1)Engine Block.

2)D.C.Generator.

3) Electric Solenoids.

4)

5)

6)

7)Engine Block Oil Pan.

8)Solenoid Covers.

9)

10)Front Engine Crank Pulley.

11)D.C.Generator Pulley.

12)Engine Crank Balancer & Output Shaft.

13)D.C.Generator Electrical Connections.

FIG. 3 page 2

Right Side View Engine Block

1)Engine Block.

2)D.C.Generator.

3)Electric Solenoids.

4)

5)

6)

7)Engine Block Oil Pan.

8)Solenoid Covers.

9)

10)Front Engine Crank Pulley.

11)D.C.Generator Pulley.

12)Engine Crank Balancer & Output Shaft.

FIG. 4 page 3

Rear View Of The Engine Block

1) Engine Block.

2) D.C.Generator.

3)

4)

5)

6) Balanced Engine Crank, Dampener & Output Shaft.

7) Engine Block Oil Pan.

8) Solenoid Covers.

9) Generator Braces.

FIG. 5 page 4

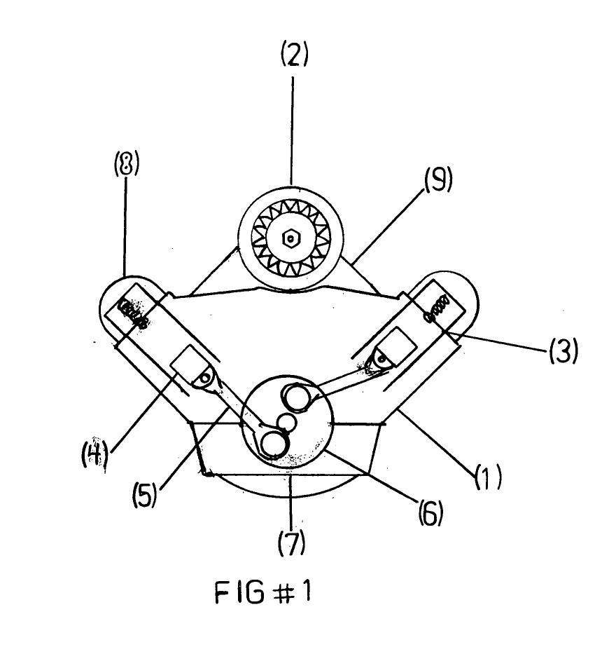

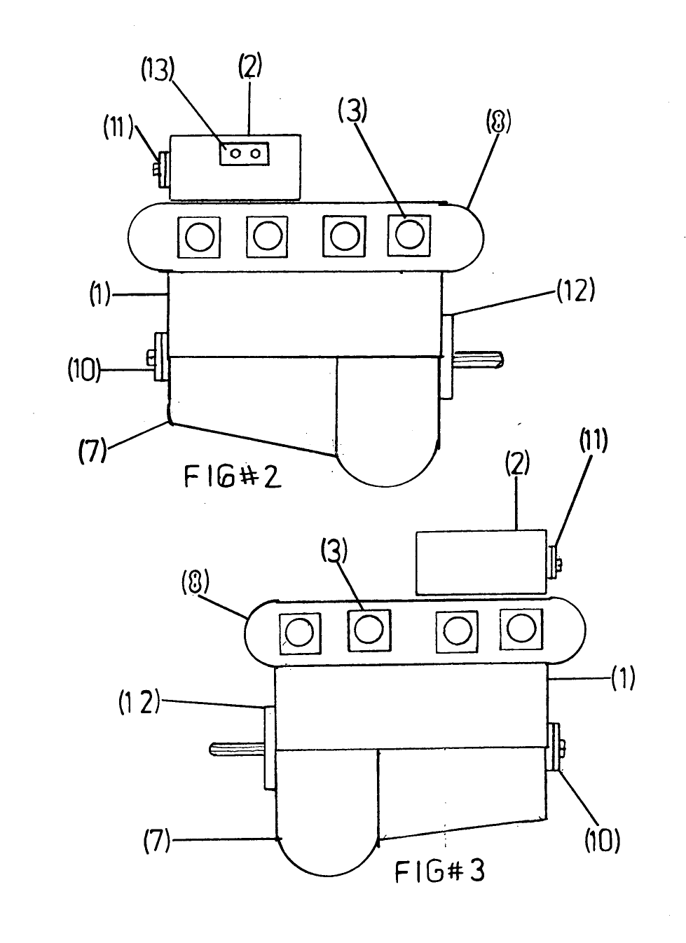

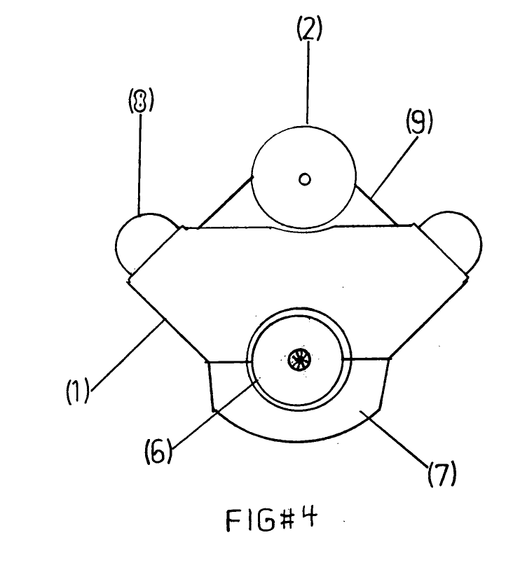

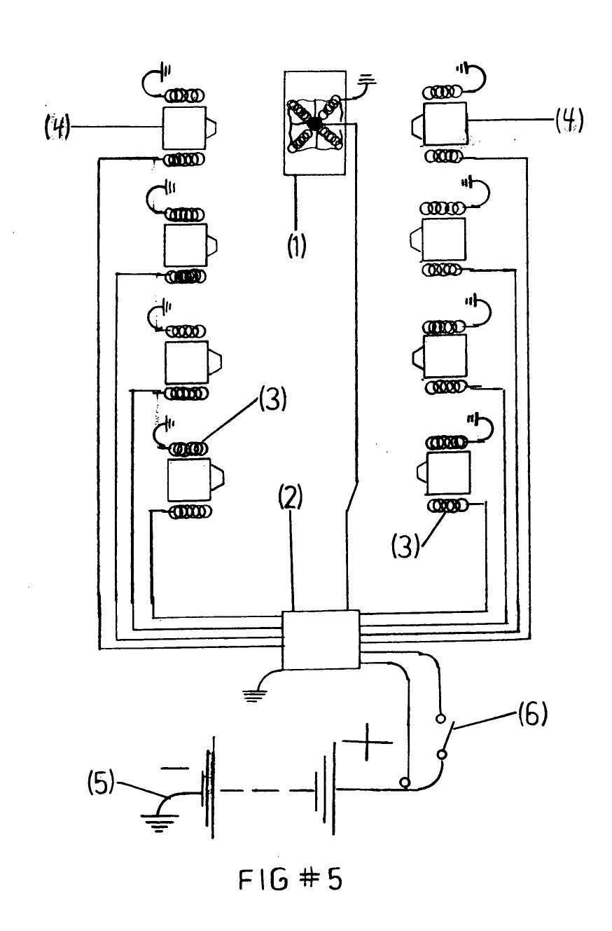

Engine Electrical Schematic

1) D.C.Generator.

2) Computer, Controler.

3) Electric Solenoids.

4) Solenoid Plungers.

5) D.C. Battery.

6) Ignition Switch.

1. What I Tim Leigh McCormick claim as My Invention Is
The Speed. Of. Light. Engine.
The Technology of the Formula for the Design of the PowerPlant/Engine Named
S.O.L.E:
The Speed. of. Light. Engine.
